(19) United States
(12) Patent Application Publication
(10) Pub. No.: US 2012/0134359 A1
(43) Pub. Date: May 31, 2012

(54) SWITCH AND SWITCHING METHOD

(75) Inventor: Yukihiro NAKAGAWA, Kawasaki (JP)

(73) Assignee: FUJITSU LIMITED, Kawasaki (JP)

(21) Appl. No.: 13/227,925

(22) Filed: Sep. 8, 2011

(30) Foreign Application Priority Data
Nov. 26, 2010 (JP) 2010-264335

(51) Int. Cl. H04L 12/56

(52) U.S. Cl. 370/392

(57) ABSTRACT

A switch includes a plurality of port units, a tag attaching unit, a switching unit, and a tag removing unit. Each of the plurality of port units includes a port configured to receive a packet or transmit a packet. The tag attaching unit determines a sub-group identifier on the basis of an input port identifier for identifying an input port which has received an input packet and a group identifier included in the input packet for identifying a group of ports, and attaches a sub-group tag including the determined sub-group identifier to the input packet to acquire an augmented packet. The switching unit determines an output port for outputting the input packet on the basis of the determined sub-group identifier, the group identifier, and a destination address included in the augmented packet. The tag removing unit removes the attached sub-group tag from the augmented packet to acquire the input packet.

### CROSS-REFERENCE TO RELATED APPLICATION

This application is based upon and claims the benefit of priority of the prior Japanese Patent Application No. 2010-264335, filed on Nov. 26, 2010, the entire contents of which are incorporated herein by reference.

### FIELD

The embodiments discussed herein are related to a switch and a switching method.

### BACKGROUND

In recent years, a blade server which accommodates a plurality of servers called “blades” that are detachable from a housing of the blade server has been developed and broadly used. Each of the blades installed in such a blade server has hardware including a central processing unit (CPU), a memory, an input/output (I/O) bus, and a storage unit, which is required to perform functions of a server. Furthermore, the blade server includes a switch blade. The switch blade integrates networks for the blades and controls packet transfer among the blades or to an external switch. The blades are allowed to be connected to one another or individually connected to an external network through the switch blade.

Moreover, a single blade server is shared among a plurality of sections and duties in many company environments, and therefore, a switch included in the switch blade is required to perform traffic separation according to the sections and the duties in addition to traffic separation according to the general virtual local area network (VLAN). Therefore, in order to realize partitions according to the sections and the duties, a function called an “extended VLAN” has been proposed, in which partitions different from those according to a conventional VLAN are dynamically defined on a single switch.

In order to transfer an arbitrary packet to a desired destination using such a switch, first, a media access control (MAC) address of the destination, which is written in the packet, is referred to. In general, an internal memory of the switch or an external memory which is accessible by the switch stores an MAC address table used for packet routing. The MAC address table stores information regarding the correspondence relationships between port identifiers (IDs) indentifying respective ports of the switch and MAC addresses.

Therefore, the switch searches the MAC address table for a port ID corresponding to an MAC address and a VLAN group of the destination and causes the port identified by the port ID to output the packet. Furthermore, when the switch supports the extended VLAN, setting of logical separation according to the extended VLAN may be performed.

Japanese Laid-open Patent Publication No. 2003-318937, Japanese Laid-open Patent Publication No. 2004-266874, and Japanese Laid-open Patent Publication No. 2010-130605 disclose related techniques.

### SUMMARY

According to an aspect of the present invention, provided is a switch including a plurality of port units, a tag attaching unit, a switching unit, and a tag removing unit. Each of the plurality of port units includes a port configured to receive a packet or transmit a packet. The tag attaching unit is configured to determine a sub-group identifier on the basis of an input port identifier for identifying an input port which has received an input packet and a group identifier for identifying a group of ports. The group identifier is included in the input packet. The tag attaching unit is also configured to attach a sub-group tag including the determined sub-group identifier to the input packet to acquire an augmented packet. The switching unit is configured to determine an output port for outputting the input packet on the basis of the determined sub-group identifier, the group identifier, and a destination address included in the augmented packet. The tag removing unit is configured to remove the attached sub-group tag from the augmented packet to acquire the input packet.

The object and advantages of the invention will be realized and attained by means of the elements and combinations particularly pointed out in the claims. it is to be understood that both the foregoing general discussion and the following detailed discussion are exemplary and explanatory and are not restrictive of the invention, as claimed.

### BRIEF DESCRIPTION OF DRAWINGS

FIG. 1 is a diagram illustrating an exemplary functional configuration of a switch according to an embodiment of the present invention;

FIG. 2 is a diagram illustrating an exemplary functional configuration of a switch according to an embodiment of the present invention;

FIG. 3 is a diagram illustrating an exemplary functional configuration of a conventional switch;

FIG. 4A is a diagram illustrating an exemplary arrangement of switches in a standard three-layer model;

FIG. 4B is a diagram illustrating an exemplary arrangement of switches in a three-layer model in virtual environment according to an embodiment of the present invention;

FIG. 5A is a diagram illustrating exemplary arrangements of switches in a three-layer model according to an embodiment of the present invention;

FIG. 5B is a diagram illustrating an exemplary configuration of a network using extended VLANs according to an embodiment of the present invention;

FIG. 6A is a diagram illustrating exemplary setting of VLANs for respective ports according to an embodiment of the present invention;

FIG. 6B is a diagram illustrating exemplary setting of extended VLANs for respective ports according to an embodiment of the present invention;

FIG. 7A is a diagram illustrating an exemplary arrangements of switches in a four-layer model according to an embodiment of the present invention;

FIG. 7B is a diagram illustrating an exemplary configuration of a network using extended VLANs according to an embodiment of the present invention;

FIG. 8A is a diagram illustrating exemplary setting of VLANs for respective ports according to an embodiment of the present invention;

FIG. 8B is a diagram illustrating exemplary setting of extended VLANs for respective ports according to an embodiment of the present invention;

FIG. 9 is a diagram illustrating an exemplary operation flow of a switch according to an embodiment of the present invention;

FIG. 10 is a diagram illustrating an exemplary operation flow of a conventional switch;

FIG. 11 is a diagram illustrating an exemplary functional configuration of a switch according to an embodiment of the present invention; and

FIG. 12 is a diagram illustrating an exemplary system configuration of a computer.

### DESCRIPTION OF EMBODIMENTS

A VLAN tag includes an identifier (ID) called VLAN ID. In general, the VLAN ID is 12-bit data and discriminates 4094 VLANs. Note that VLAN IDs corresponding to 0 and 4095 are reserved.

Using an Ethernet (registered trademark) switch, a single physical network may be utilized as a plurality of virtual networks according to a virtual network technique which conforms to the IEEE802.1Q standard. In order to identify the virtual networks, a VLAN tag is attached to a header of the packet.

On the other hand, in a data center, in general, a plurality of servers are arranged in a layered manner for performing task processes. For example, in a three-layer model, a task process is divided into three layers such as a presentation layer, a logic layer, and a data storage layer, and servers corresponding to the respective layers are arranged and connected to one another through a network.

In environments, such as a cloud data center environment, in which servers are virtually integrated, it may be required to implement an N-layer model with a flat network configuration. In this case, the number of required VLANs increases N-fold, and accordingly, there arises a problem in that the number of VLANs runs short.

Thus, it is preferable to provide a switch which supports VLANs more than an upper limit of the number of the VLAN IDs.

The switch discussed in the embodiments may support VLANs more than an upper limit of the number of the VLAN IDs.

Hereinafter, embodiments of a switch will be discussed in detail with reference to the accompanying drawings. Note that the embodiments are not limited to those discussed ones.

### Embodiments

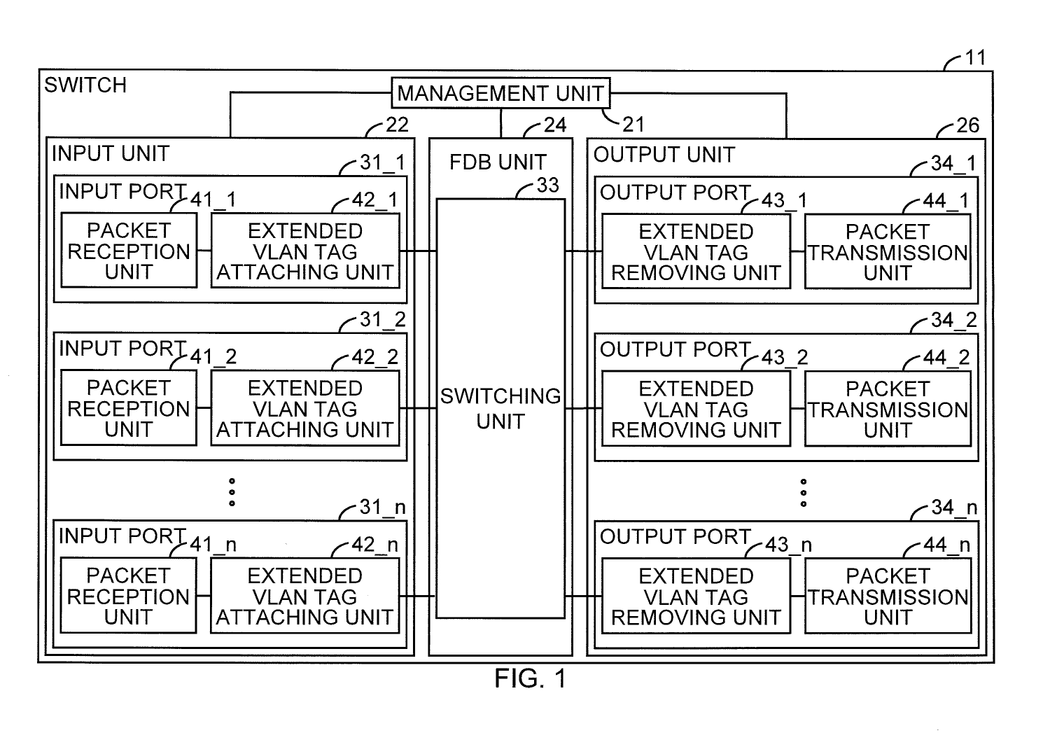

FIG. 1 illustrates an exemplary functional configuration of a switch according to the present embodiment. As illustrated in FIG. 1, a switch 11 includes a management unit 21, an input unit 22, a forwarding database (FDB) unit 24, and an output unit 26.

The input unit 22 includes a plurality of input ports 31_1 to 31_n. The input port 31_1 includes a packet reception unit 41_1 which receives a packet and an extended VLAN tag attaching unit 42_1 which attaches an extended VLAN tag including an extended VLAN ID (identification information of an extended VLAN) to the received packet. Similarly, the input ports 31_2 to 31-n include packet reception units 41_2 to 41_n, respectively, which receive packets and extended VLAN tag attaching units 42_2 to 42_n, respectively, which attach extended VLAN tags to the received packets.

The FDB unit 24 includes a switching unit 33. The switching unit 33 determines a destination of a packet within a range of a sub-group identified by the extended VLAN ID. Specifically, the switching unit 33 divides a group which shares the same VLAN ID into sub-groups on the basis of the extended VLAN ID, and performs switching within a sub-group obtained on the basis of the extended VLAN ID as a domain. Therefore, when a packet is broadcasted, for example, the packet is transmitted to all ports which belong to the same extended VLAN identified with the extended VLAN ID.

The output unit 26 includes a plurality of output ports 34_1 to 34_n. The output port 34_1 includes an extended VLAN tag removing unit 43_1 which removes the extended VLAN tag from a packet whose destination has been determined by the switching unit 33 and a packet transmission unit 44_1 which transmits the packet. Similarly, the output ports 34_2 to 34_n include extended VLAN tag removing units 43_2 to 43_n, respectively, which remove the extended VLAN tags and packet transmission units 44_2 to 44_n, respectively, which transmit packets.

The management unit 21 is a controller which controls operation of the switch 11 and is realized by a combination of a CPU and a memory, for example. The management unit 21 controls an operation of attaching an extended VLAN tag and an operation of removing the extended VLAN tag and changes operations of the input unit 22 and the output unit 26. The management unit 21 controls and changes a switching operation performed by the FDB unit 24.

Although a case where the extended VLAN tag attaching units and the extended VLAN tag removing units are disposed in the input ports and the output ports, respectively, in the example illustrated in FIG. 1, the extended VLAN tag attaching units and the extended VLAN tag removing units may be disposed in the FDB unit.

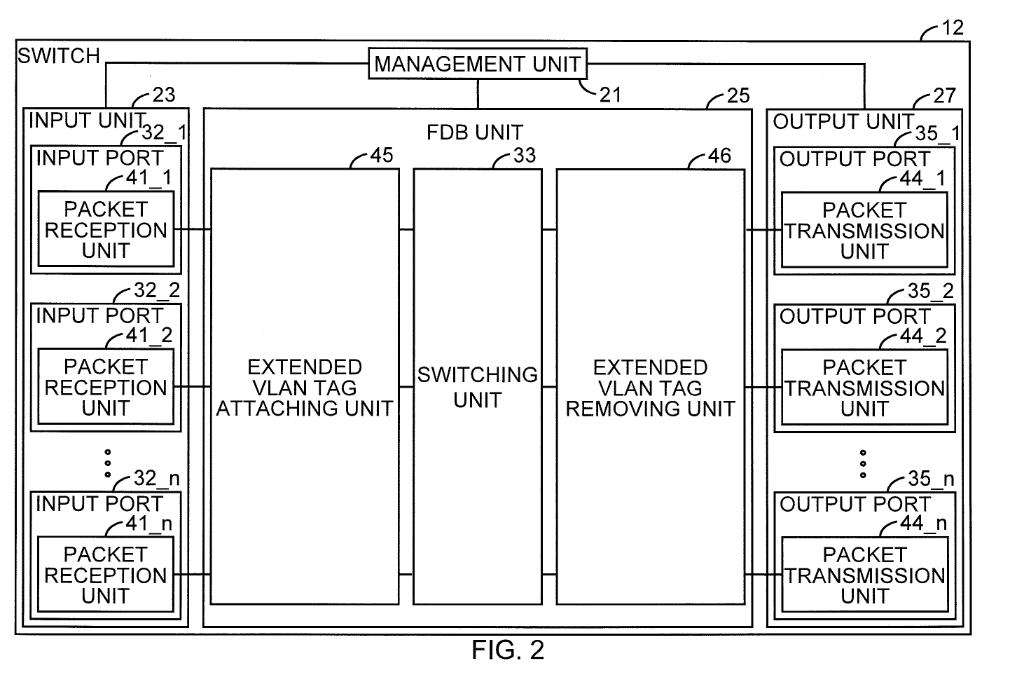

FIG. 2 illustrates an exemplary functional configuration of a switch according to another embodiment of the present invention in a case where an extended VLAN tag attaching unit and an extended VLAN tag removing unit are included in the FDB unit. A switch 12 illustrated in FIG. 2 includes a management unit 21, an input unit 23, an FDB unit 25, and an output unit 27.

The input unit 23 includes a plurality of input ports 32_1 to 32_n. The input port 32_1 includes a packet reception unit 41_1 which receives a packet. Similarly, the input ports 32_2 to 32_n include packet reception units 41_2 to 41_n, respectively, which receive packets.

The FDB unit 25 includes an extended VLAN tag attaching unit 45, a switching unit 33, and an extended VLAN tag removing unit 46. The extended VLAN tag attaching unit 45 attaches an extended VLAN tag to a received packet on the basis of an input port ID and a VLAN ID. The switching unit 33 determines a destination of the packet within a range of a sub-group identified by the extended VLAN ID. The extended VLAN tag removing unit 46 removes the extended VLAN tag from the packet whose destination has been determined by the switching unit 33.

The output unit 27 includes a plurality of output ports 35_1 to 35_n. The output port 35_1 includes a packet transmission unit 44_1 which transmits a packet. Similarly, the output ports 35_2 to 35_n include packet transmission units 44_2 to 44_n, respectively, which transmit packets.

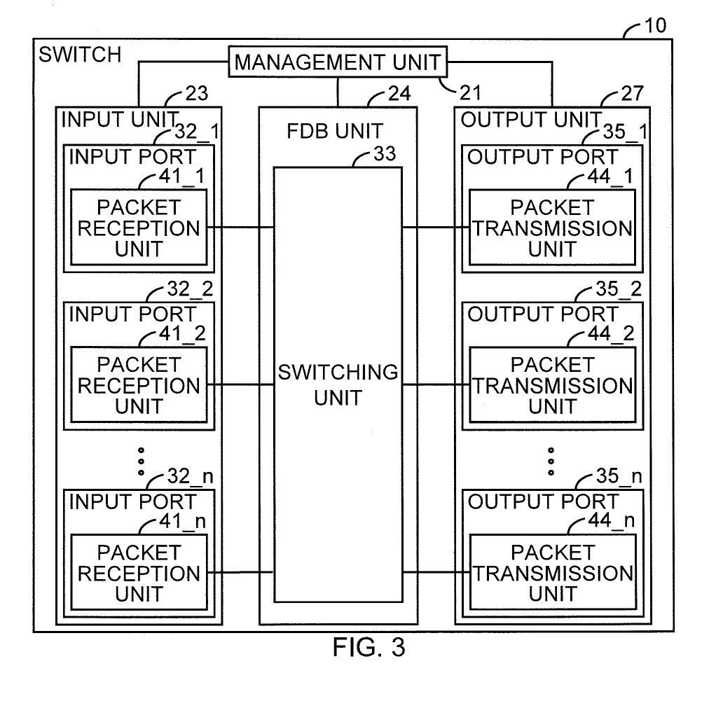

FIG. 3 illustrates an exemplary functional configuration of a conventional switch. A switch 10 illustrated in FIG. 3 does not include an extended VLAN tag attaching unit and an extended VLAN tag removing unit. Specifically, the switch 10 includes a management unit 21, an input unit 23, an FDB unit 24, and an output unit 27.

The input unit 23 includes a plurality of input ports 32_1 to 32_n. The input port 32_1 includes a packet reception unit 41_1 which receives a packet. Similarly, the input ports 32_2 to 32_n include packet reception units 41_2 to 41_n, respectively, which receive packets.

The FDB unit 24 includes a switching unit 33. The switching unit 33 determines a destination of a packet within a range of a group identified by a VLAN ID.

The output unit 27 includes a plurality of output ports 35_1 to 35_n. The output port 35_1 includes a packet transmission unit 44_1 which transmits a packet. Similarly, the output ports 35_2 to 35_n include packet transmission units 44_2 to 44_n, respectively, which transmit packets.

In the switch 10 illustrated in FIG. 3, packet control within a range of a group of a VLAN is performed but packet control within a range of a sub-group of an extended VLAN is not performed, and accordingly, the number of groups is limited to the upper limit (4094) of the number of the VLAN IDs.

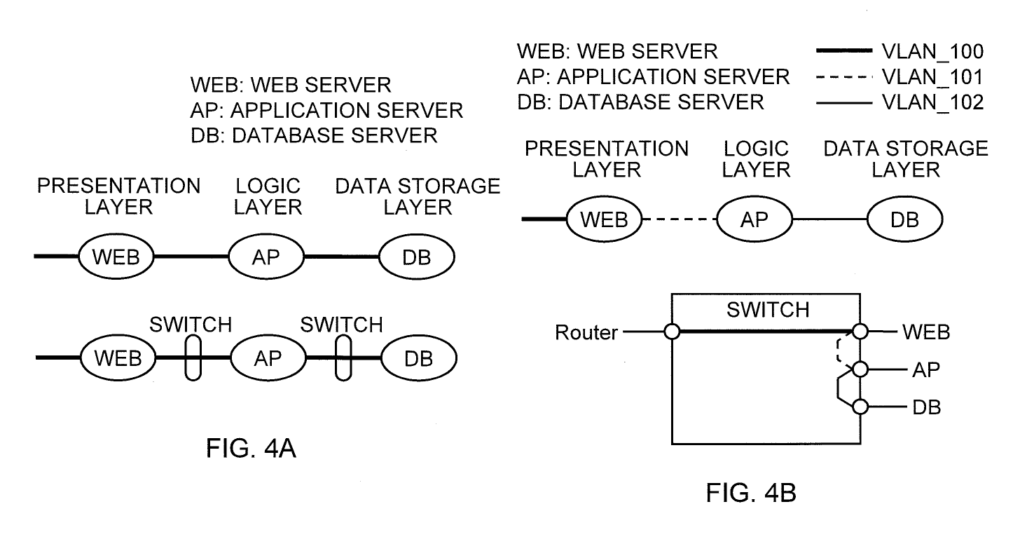

FIG. 4A illustrates an exemplary arrangement of switches in a standard three-layer model. When switches are to be physically disposed among a World Wide Web (WEB) server corresponding to a presentation layer, an application (AP) server corresponding to a logic layer, and a database (DB) server corresponding to a data storage layer, switches are disposed between the WEB server and the AP server and between the AP server and the DB server.

FIG. 4B illustrates an exemplary arrangement of switches in a three-layer model in virtual environment. In a virtual environment using VLANs, a router, a WEB server, an AP server, and a DB server are connected to ports of a switch. Then, the ports for the router and the Web server are assigned to a VLAN_100, ports for the WEB server and the AP server are assigned to a VLAN_101, and the ports for the AP server and the DB server are assigned to a VLAN_102. Thus, a plurality of servers may be connected to one another via a single switch by using VLANs.

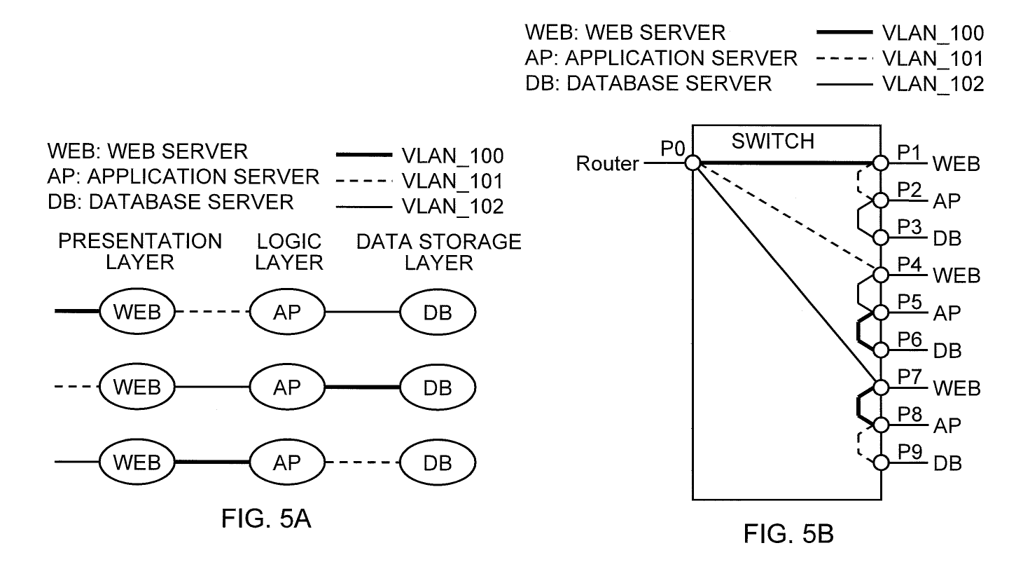

FIG. 5A illustrates an exemplary arrangements of switches in a three-layer model according to the present embodiment. A case where three models are included in the configuration will be discussed. Each model includes three layers, i.e., a WEB server corresponding to a presentation layer, an AP server corresponding to a logic layer, and a DB server corresponding to a data storage layer.

FIG. 5B illustrates an exemplary configuration of a network using extended VLANs according to the present embodiment. A router is connected to a port P0 of a switch, and a first WEB server, a first AP server, and a first DB server are connected to ports P1 to P3, respectively. Furthermore, a second WEB server, a second AP server, and a second DB server are connected to ports P4 to P6, respectively. Moreover, a third WEB server, a third AP server, and a third DB server are connected to ports P7 to P9, respectively.

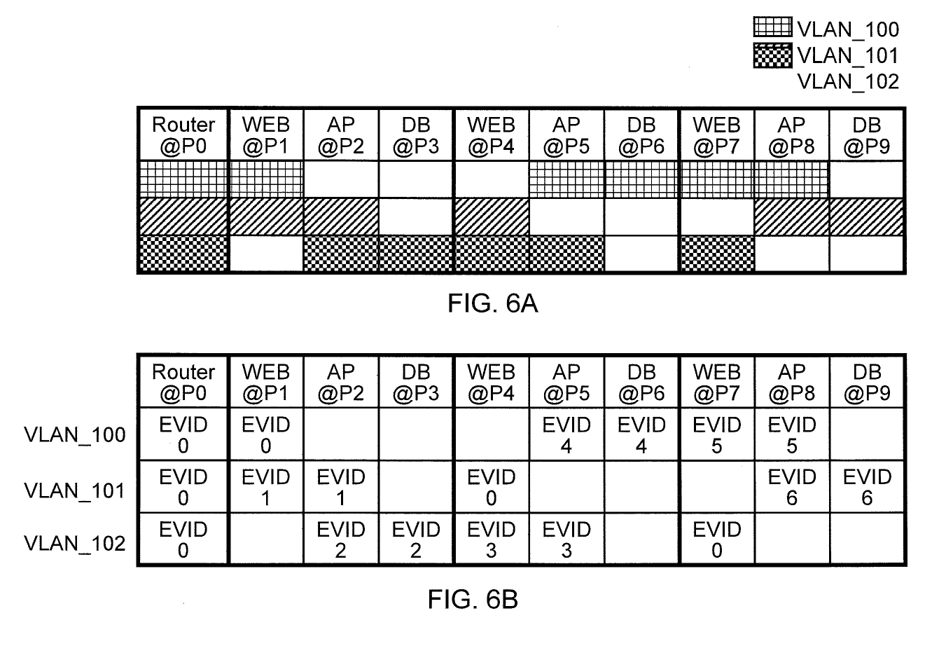

FIG. 6A illustrates exemplary setting of VLANs for respective ports according to the present embodiment. FIG. 6B illustrates exemplary setting of extended VLANs for respective ports according to the present embodiment. In FIGS. 6A and 6B, the VLANs to which each port belongs are specified. That is, the setting is performed such that ports which are allowed to be communicated with each other belong to the same VLAN and that ports to be separated do not belong to the same VLAN. Specifically, the ports P0, P1, P5, P6, P7, and P8 are assigned to a VLAN_100, the ports P0, P1, P2, P4, P8, and P9 are assigned to a VLAN_101, and the ports P0, P2, P3, P4, P5, and P7 are assigned to a VLAN_102.

As for the extended VLANs, an extended VLAN ID EVID0 is assigned to the VLAN_100 to VLAN_102 of the port P0, the VLAN_100 of the port P1, the VLAN_101 of the port P4, and the VLAN_102 of the port P7.

An extended VLAN ID EVID1 is assigned to the VLAN_101 of the port P1 and the VLAN_101 of the port P2, and an extended VLAN ID EVID2 is assigned to the VLAN_102 of the port P2 and the VLAN_102 of the port P3. An extended VLAN ID EVID3 is assigned to the VLAN_102 of the port P4 and the VLAN_102 of the port P5, and an extended VLAN ID EVID4 is assigned to the VLAN_100 of the port P5 and the VLAN_100 of the port P6. An extended VLAN ID EVID5 is assigned to the VLAN_100 of the port P7 and the VLAN_100 of the port P8, and an extended VLAN ID EVID6 is assigned to the VLAN_101 of the port P8 and the VLAN_101 of the port P9.

As discussed above, when the extended VLANs are assigned, the ports having the same extended VLAN ID define boarders of broadcast, and accordingly, a packet may be controlled to be transmitted within one of sub-groups obtained by dividing groups obtained through logical division using the VLANs. For example, the connection between the first WEB server on the port P1 and the first AP server on the port P2 and the connection between the third AP server on the port P8 and the third DB server on the port P9 belong to the same VLAN_101, but belong to different extended VLANs, that is, the extended_VLAN_1 and the extended_VLAN_6, respectively, therefore the first WEB server on the port P1 does not communicate with the third AP server on the port P8 owing to the restricted broadcast domains.

Accordingly, in spite of the fact that only the three VLANs including the VLAN_100 to VLAN_102 are used, three systems of the three-layer WEB-AP-DB configuration may be managed by the single switch in a flat manner, that is, without arranging switches in a layered manner.

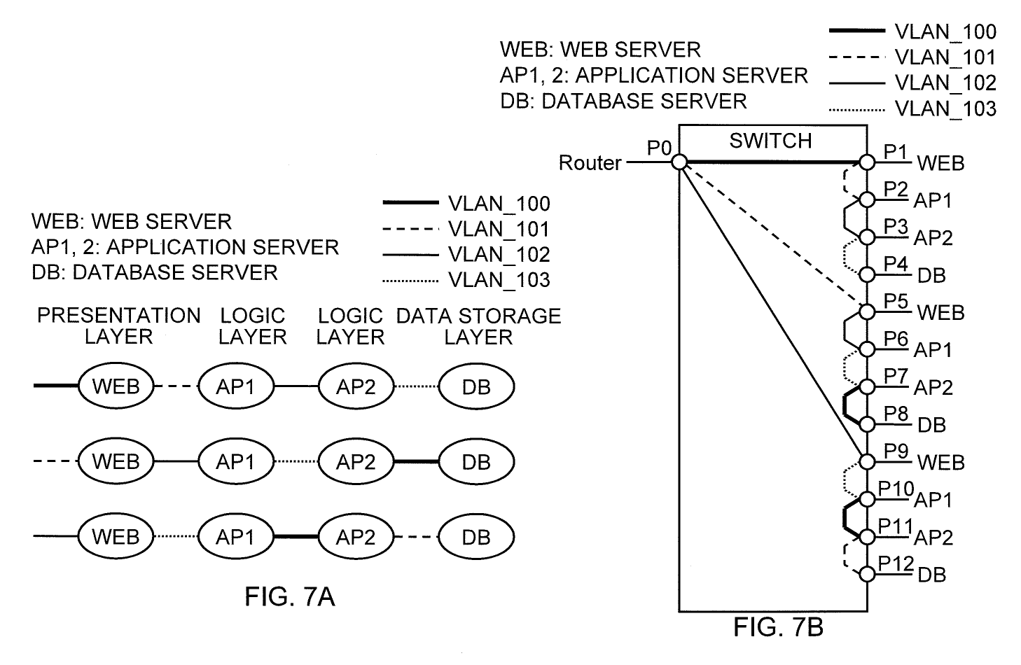

FIG. 7A illustrates an exemplary arrangements of switches in a four-layer model according to the present embodiment. Specifically, the configuration includes three models having four layers including a WEB server corresponding to a presentation layer, an AP1 server corresponding to a first logic layer, an AP2 server corresponding to a second logic layer, and a DB server corresponding to a data storage layer.

FIG. 7B illustrates an exemplary configuration of a network using extended VLANs according to the present embodiment. A router is connected to a port P0 of a switch, and a first WEB server, a first AP1 server, a first AP2 server, and a first DB server are connected to ports P1 to P4, respectively. Furthermore, a second WEB server, a second AP1 server, a second AP2 server, and a second DB server are connected to ports P5 to P8, respectively. Then, a third WEB server, a third AP1 server, a third AP2 server, and a third DB server are connected to ports P9 to P12, respectively.

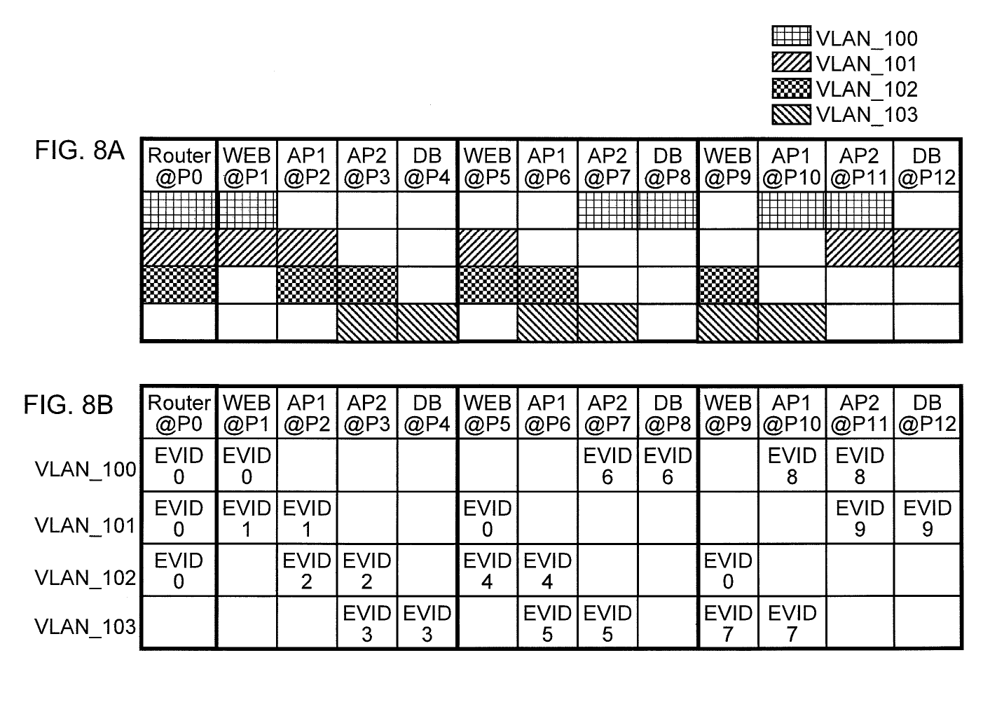

FIG. 8A illustrates exemplary setting of VLANs for respective ports according to the present embodiment. FIG. 8B illustrates exemplary setting of extended VLANs for respective ports according to the present embodiment. As illustrated in FIG. 8A, the ports P0, P1, P7, P8, P10, and P11 are assigned to a VLAN_100, the ports P0, P1, P2, P5, P11, and P12 are assigned to a VLAN_101, and the ports P0, P2, P3, P5, P6, and P9 are assigned to a VLAN_102. Then, ports P3, P4, P6, P7, P9, and P10 are assigned to a VLAN_103.

As for extended VLANs, as illustrated in FIG. 8B, an extended VLAN ID EVID0 is assigned to the VLAN_100 to VLAN_102 of the port P0, the VLAN_100 of the port P1, the VLAN_101 of the port P5, and the VLAN_102 of the port P9.

An extended VLAN ID EVID1 is assigned to the VLAN_101 of the port P1 and the VLAN_101 of the port P2, and an extended VLAN ID EVID2 is assigned to the VLAN_102 of the port P2 and the VLAN_102 of the port P3. An extended VLAN ID EVID3 is assigned to the VLAN_103 of the port P3 and the VLAN_103 of the port P4.

An extended VLAN ID EVID4 is assigned to the VLAN_102 of the port P5 and the VLAN_102 of the port P6, and an extended VLAN ID EVID5 is assigned to the VLAN_103 of the port P6 and the VLAN_103 of the port P7. An extended VLAN ID EVID6 is assigned to the VLAN_100 of the port P7 and the VLAN_100 of the port P8, and an extended VLAN ID EVID7 is assigned to the VLAN_103 of the port P9 and the VLAN_103 of the port P10. An extended VLAN ID EVID8 is assigned to the VLAN_100 of the port P10 and the VLAN_100 of the port P11, and an extended VLAN ID EVID9 is assigned to the VLAN_101 of the port P11 and the VLAN_101 of the port P12.

As discussed above, when the extended VLANs are assigned, the ports having the same extended VLAN ID define boarders of broadcast, and accordingly, a packet may be controlled to be transmitted within one of sub-groups obtained by dividing groups obtained through logical division using the VLANs.

Accordingly, in spite of the fact that only the four VLANs including the VLAN_100 to VLAN_103 are used, three systems of the four-layer WEB-AP1-AP2-DB configuration may be managed by the single switch in a flat manner, that is, without arranging switches in a layered manner.

Although the discussions have been made taking the three-layer configuration and the four-layer configuration as examples, it is apparent that an arbitrary number of layers and an arbitrary number of systems is applicable.

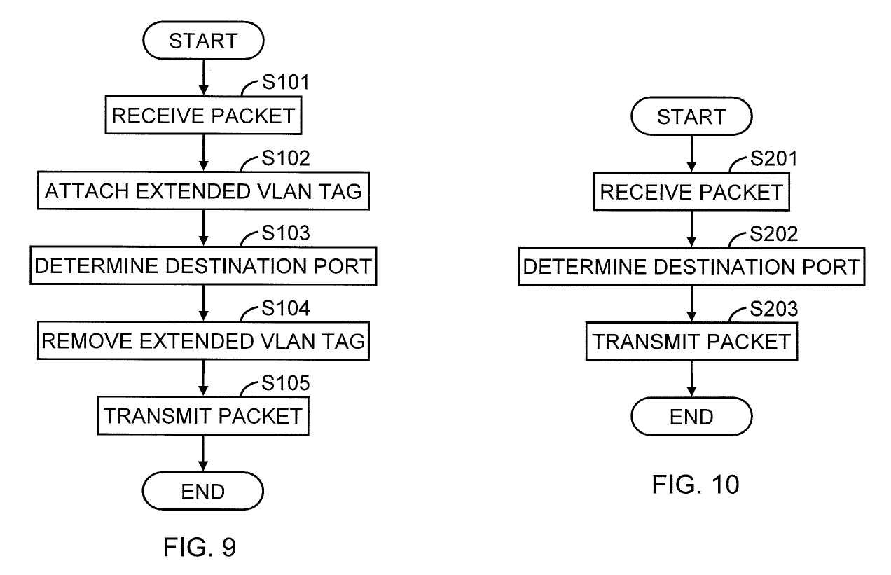

FIG. 9 illustrates an exemplary operation flow of the switch 11 according to the present embodiment. Note that, although a discussion will be made taking the switch 11 as an example with reference to FIG. 9, the switch 12 operates similarly to the switch 11.

In S101, the switch 11 receives a packet.

In S102, the switch 11 attaches an extended VLAN tag to the received packet on the basis of an input port ID and a VLAN ID.

In S103, the switch 11 determines a destination port on the basis of a destination address (DA), the VLAN ID, and the extended VLAN ID.

In S104, the switch 11 removes the extended VLAN tag from the packet.

In S105, the switch 11 transmits the packet, and terminates the process.

FIG. 10 illustrates an exemplary operation flow of the conventional switch 10.

In S201, the switch 10 receives a packet.

In S202, the switch 10 determines a destination port on the basis of a destination address (DA) and a VLAN ID.

In S203, the switch 10 transmits the packet, and terminates the process.

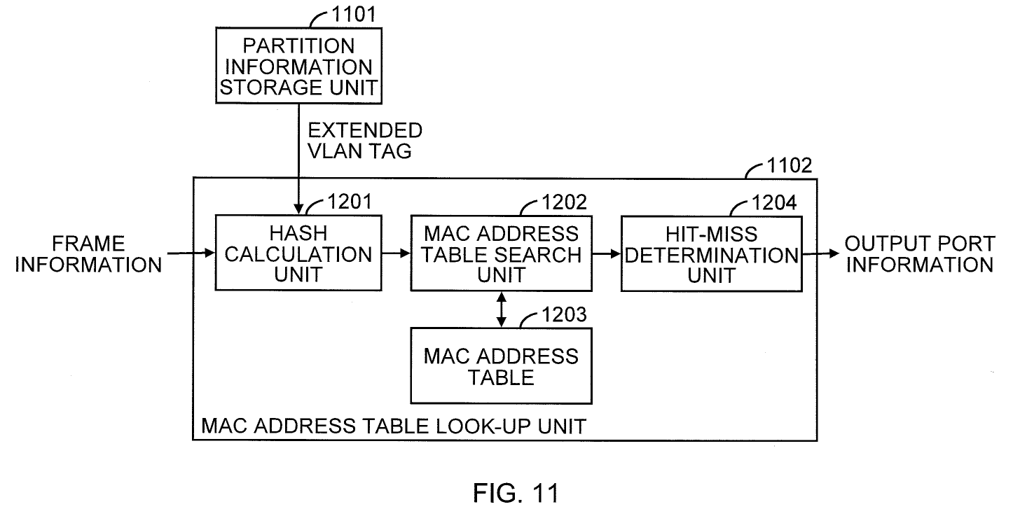

FIG. 11 illustrates an exemplary functional configuration of a switch for determining an output port on the basis of an extended VLAN ID according to the present embodiment. As discussed above, the switches 11 and 12 according to the present embodiment perform a packet transmission with reference to an extended VLAN ID in addition to a conventional VLAN ID and an MAC address. Specifically, a switching unit is realized as an MAC address table look-up unit 1102. The MAC address table look-up unit 1102 includes a hash calculation unit 1201, an MAC address table search unit 1202, an MAC address table 1203, and a hit-miss determination unit 1204.

When a packet is input to a port of the switch 11 or 12, frame information of the input packet is input to the MAC address table look-up unit 1102. An MAC address and a VLAN ID included in the frame information are input to the hash calculation unit 1201, and simultaneously, an extended VLAN ID is input to the hash calculation unit 1201. The extended VLAN ID identifies extended VLAN to which the packet belongs and is read from a partition information storage unit 1101 with reference to the port ID of the port to which the packet is input. The hash calculation unit 1201 calculates a hash value on the basis of the input information. The calculated hash value is input to the MAC address table search unit 1202. The MAC address table search unit 1202 uses the calculated hash value to search the MAC address table 1203.

The MAC address table 1203 stores a data string in which an output port ID is corresponded to an MAC address, a VLAN ID, and an extended VLAN ID. The MAC address table search unit 1202 searches for a data string corresponding to the input packet among a plurality of data strings stored in the MAC address table 1203.

Specifically, the MAC address table search unit 1202 searches for an entry of the MAC address table, which includes the input MAC address (destination address), the input VLAN ID (group information of the VLAN), and the input extended VLAN ID (group information of the extended VLAN), on the basis of the calculated hash value. When an entry including the input MAC address, the input VLAN ID, and the input extended VLAN ID is detected, the MAC address table search unit 1202 outputs a signal indicating a successful search and information regarding a corresponding output port to the hit-miss determination unit 1204.

When no entry including the input MAC address, the input VLAN ID, and the input extended VLAN ID is detected, the MAC address table search unit 1202 outputs a signal indicating a failed search. When the MAC address table 1203 has no entry including the input MAC address, the input VLAN ID, and the input extended VLAN ID, the MAC address table search unit 1202 stores a new entry including the input MAC address, the input VLAN ID, and the input extended VLAN ID. Accordingly, in this case, the MAC address table search unit 1202 also functions as registration means for newly registering data strings (information representing the correspondence relationship among the MAC address, the VLAN ID, and the extended VLAN ID) in the MAC address table 1203.

The hit-miss determination unit 1204 determines an output port used to transmit the input packet to the destination address. Specifically, upon receiving the signal indicating a successful search and the information regarding the output port from the MAC address table search unit 1202, the hit-miss determination unit 1204 notifies an output port module corresponding to the output port of the information regarding the output port in order to output the packet recorded in a stream memory from the output port.

Upon receiving the signal indicating a failed search from the MAC address table search unit 1202, the hit-miss determination unit 1204 performs flooding using the packet recorded in a stream memory. Specifically, the hit-miss determination unit 1204 outputs a flooding instruction to port modules which belong to the same extended VLAN and the same VLAN as those of the packet.

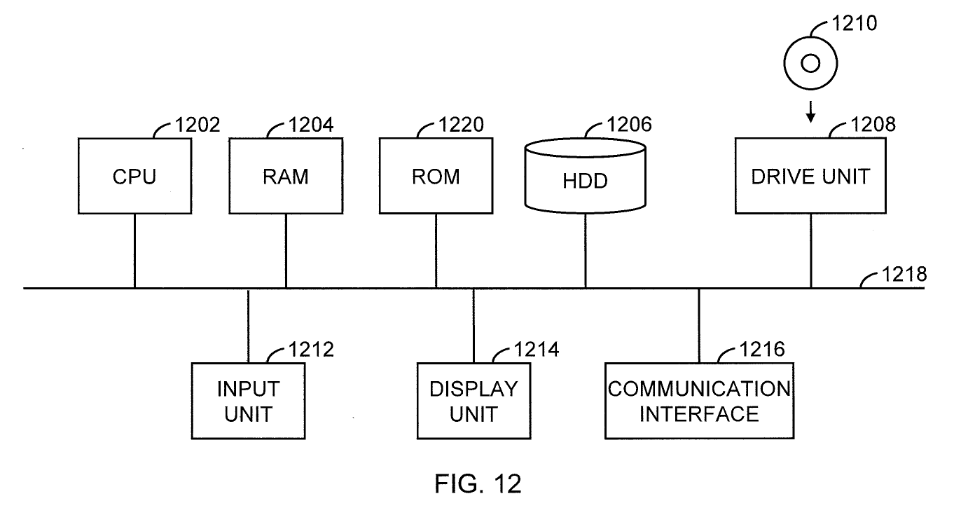

The functions of the switch may be achieved by a computer by executing software. FIG. 12 illustrates an exemplary system configuration of a computer. The computer illustrated in FIG. 12 includes a CPU 1202 for executing the software such as operating system (OS) and application programs, a random access memory (RAM) 1204 for temporarily storing data, a hard disk drive (HDD) 1206 for storing data, a drive unit 1208 for reading data from and/or writing data to a computer-readable recording medium 1210, an input unit 1212 for accepting user input, a display unit 1214 for displaying data, and a communication interface 1216 for establishing a connection to a network. These components are connected to each other via a bus 1218. The software may be stored, when delivered, in the computer-readable recording medium 1210 such as a compact disc (CD), a compact disc read-only memory (CD-ROM), CD recordable (CD-R), CD rewritable (CD-RW) or the like, a digital versatile disc (DVD), DVD-ROM, DVD-RAM, DVD-R, DVD plus R (DVD+R), DVD-RW, DVD plus RW (DVD+RW), HD DVD or the like, a Blu-ray disc, a magnetic disk, an optical disc, or a magneto-optical disc, installed onto the HDD 1206 from the computer-readable recording medium 1210, and loaded into the RAM 1204 from the HDD 1206 when executed by the CPU 1202. The software may be delivered over the network. Alternatively, the software may be stored in advance in a read-only memory (ROM) 1220 to be read out and executed by the CPU 1202.

As discussed above, according to the embodiments, a destination of a packet is determined within a range of a sub-group identified by an extended VLAN ID by attaching an extended VLAN tag including the extended VLAN ID on the basis of a port ID of a port which received the packet and the VLAN ID. Then, the extended VLAN tag of the packet whose destination has been determined by the switching unit is removed. Therefore, the switch may support the VLANs more than an upper limit of the number of VLAN IDs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been discussed in detail, it should be understood that the various changes, substitutions, and alterations could be made hereto without departing from the spirit and scope of the invention.

What is claimed is:

1. A switch comprising:
a plurality of port units each of which includes a port configured to receive a packet or transmit a packet;
a tag attaching unit configured to
determine a sub-group identifier on the basis of an input port identifier for identifying an input port which has received an input packet and a group identifier for identifying a group of ports, the group identifier being included in the input packet, and
attach a sub-group tag including the determined sub-group identifier to the input packet to acquire an augmented packet;
a switching unit configured to
determine an output port for outputting the input packet on the basis of the determined sub-group identifier, the group identifier, and a destination address included in the augmented packet; and
a tag removing unit configured to
remove the attached sub-group tag from the augmented packet to acquire the input packet.

2. The switch according to claim 1, wherein
the tag attaching unit is disposed in a port unit including a port configured to receive a packet, and
the tag removing unit is disposed in a port unit including a port configured to transmit a packet.

3. The switch according to claim 1, wherein
the tag attaching unit, the tag removing unit, and the switching unit are disposed in a unit different from the plurality of port units.

4. The switch according to claim 1, wherein
output ports for transmitting the input packet are limited to ports included in a sub-group identified by the determined sub-group identifier when the input packet is broadcasted.

5. A switching method executed by a switch including a plurality of ports configured to receive a packet or transmit a packet, the switching method comprising:
determining, by the switch, a sub-group identifier on the basis of an input port identifier for identifying an input port which has received an input packet and a group identifier for identifying a group of ports, the group identifier being included in the input packet;
attaching a sub-group tag including the determined sub-group identifier to the input packet to acquire an augmented packet;
determining an output port for outputting the input packet on the basis of the determined sub-group identifier, the group identifier, and a destination address included in the augmented packet; and
removing the attached sub-group tag from the augmented packet to acquire the input packet.
